(19) United States
(12) Patent Application Publication
(10) Pub. No.: US 2026/0330308 A1
(43) Pub. Date: Oct. 22, 2026

(54) AI Augmented Data Analysis

(71) Applicant: NATIONAL INSTRUMENTS CORPORATION, Austin, TX (US)

(72) Inventor: Alejandro Barreto, Austin, TX (US)

(21) Appl. No.: 19/468,494

(22) Filed: Feb. 3, 2026

Related U.S. Application Data
(60) Provisional application No. 63/753,231, filed on Feb. 3, 2025.

(51) Int. Cl. G06N 20/00

(52) U.S. Cl. CPC G06N 20/00

(57) ABSTRACT

Apparatuses, systems, and methods for Artificial Intelligence (AI) augmented data analysis. A large language model (LLM), e.g., AI, can receive, via a user interface (UI) element embedded in a primary UI element, one or more commands for manipulating data and/or information. Further, the AI can perform the one or more commands for manipulating data and/or information. The one or more commands can include cosmetic commands as well as semantic commands. In addition, the AI can update the primary UI element with updated data and/or updated information. The update can be based, at least in part, on the performance of the one or more commands.

### PRIORITY CLAIM

This application claims benefit of priority to provisional application number 63/753,231 entitled “AI Augmented Data Analysis”, filed on Feb. 3, 2025, whose disclosure is hereby incorporated by reference in its entirety as though fully and completely set forth herein.

### TECHNICAL FIELD

The invention relates to data analysis, and more particularly to apparatuses, systems, and methods for generative Artificial Intelligence (AI) assisted data analysis, e.g., using a generative AI based system to review and refine data.

### DESCRIPTION OF THE RELATED ART

Currently, in various fields, such as science, engineering, test and measurement, and regulatory compliance, users frequently deal with large, complex datasets, including documents, requirements, test results, and intellectual property (IP). Whether these large, complex datasets are uploaded manually by a user or generated by Artificial Intelligence (AI), a user must review and refine the datasets prior to finalization. However, traditional User Interfaces (UIs) can struggle to balance powerful functionality with usability when handling such large, complex datasets. Many UI designs fail because an excessive number of UI elements can lead to overwhelming interfaces, because certain edits can be hard and/or impossible to perform with buttons alone (e.g., “replace the first test in this category with three new functional tests”), and/or because AI-generated content requires human oversight but lacks an efficient review mechanism. Accordingly, improvements are desirable.

### SUMMARY

Embodiments described herein relate to computing systems, memory media, and methods for generative Artificial Intelligence (AI) assisted data analysis, e.g., using a generative AI based system to review and refine data.

For example, in some embodiments, an AI (e.g., a large language model (LLM)) can receive, via a user interface (UI) element embedded in a primary UI element, one or more commands for manipulating data and/or information. Further, the AI can perform the one or more commands for manipulating data and/or information. The one or more commands can include cosmetic commands as well as semantic commands. In addition, the AI can update the primary UI element with updated data and/or updated information. The updated data and/or updated information can include new data and/or new information. The update can be based, at least in part, on the performance of the one or more commands.

Note that the techniques described herein can be implemented in and/or used with a number of different types of devices, including but not limited to cellular phones, tablet computers, wearable computing devices, portable computing devices, portable media players, and any of various other computing devices.

This Summary is intended to provide a brief overview of some of the subject matter described in this document. Accordingly, it will be appreciated that the above-described features are only examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE DRAWINGS

A better understanding of the disclosed embodiments can be obtained when the following detailed description of the preferred embodiments is considered in conjunction with the following drawings.

FIG. 1 illustrates an example of a computer system, according to some embodiments.

FIG. 2 illustrates an example block diagram of a server 104, according to some embodiments.

FIG. 3 illustrates an example of a system supporting a data analysis system, according to some embodiments.

FIG. 4 illustrates a block diagram of example of a method for AI assisted data analysis, according to some embodiments.

While the features described herein can be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that can appear throughout the present disclosure are provided below:
AI: Artificial Intelligence
DUT: Device Under Test
UUT: Unit Under Test
VI: Virtual Instrument
GUI: Graphical User Interface
LLM: Large Language Model
JSON: JavaScript Object Notation

### Terms

The following is a glossary of terms used in this disclosure:

Device Under Test (DUT) or Unit Under Test (UUT)—A physical device or component that is being tested.

Memory Medium—Any of various types of non-transitory memory devices or storage devices. The term “memory medium” is intended to include an installation medium, e.g., a CD-ROM, floppy disks, or tape device; a computer system memory or random-access memory such as DRAM, DDR RAM, SRAM, EDO RAM, Rambus RAM, etc.; a non-volatile memory such as a Flash, magnetic media, e.g., a hard drive, or optical storage; registers, or other similar types of memory elements, etc. The memory medium can include other types of non-transitory memory as well or combinations thereof. In addition, the memory medium can be located in a first computer system in which the programs are executed, or can be located in a second different computer system which connects to the first computer system over a network, such as the Internet. In the latter instance, the second computer system can provide program instructions to the first computer for execution. The term “memory medium” can include two or more memory mediums which can reside in different locations, e.g., in different computer systems that are connected over a network. The memory medium can store program instructions (e.g., embodied as computer programs) that can be executed by one or more processors.

Carrier Medium—a memory medium as described above, as well as a physical transmission medium, such as a bus, network, and/or other physical transmission medium that conveys signals such as electrical, electromagnetic, or digital signals.

Programmable Hardware Element—includes various hardware devices comprising multiple programmable function blocks connected via a programmable interconnect. Examples include FPGAs (Field Programmable Gate Arrays), PLDs (Programmable Logic Devices), FPOAs (Field Programmable Object Arrays), and CPLDs (Complex PLDs). The programmable function blocks can range from fine grained (combinatorial logic or look up tables) to coarse grained (arithmetic logic units or processor cores). A programmable hardware element can also be referred to as “reconfigurable logic”.

Computer System (or Computer)—any of various types of computing or processing systems, including a personal computer system (PC), mainframe computer system, workstation, network appliance, Internet appliance, personal digital assistant (PDA), television system, grid computing system, or other device or combinations of devices. In general, the term “computer system” can be broadly defined to encompass any device (or combination of devices) having at least one processor that executes instructions from a memory medium.

Processing Element (or Processor)—refers to various elements or combinations of elements that are capable of performing a function in a device, such as a user equipment or a cellular network device. Processing elements can include, for example: processors and associated memory, portions or circuits of individual processor cores, entire processor cores, processor arrays, circuits such as an ASIC (Application Specific Integrated Circuit), programmable hardware elements such as a field programmable gate array (FPGA), as well any of various combinations of the above.

Program—the term “program” is intended to have the full breadth of its ordinary meaning. The term “program” includes 1) a software program which can be stored in a memory and is executable by a processor or 2) a hardware configuration program useable for configuring a programmable hardware element.

Software Program—the term “software program” is intended to have the full breadth of its ordinary meaning, and includes any type of program instructions, code, script and/or data, or combinations thereof, that can be stored in a memory medium and executed by a processor. Exemplary software programs include programs written in text-based programming languages, such as C, C++, Pascal, Fortran, Cobol, Java, assembly language, etc.; graphical programs (programs written in graphical programming languages); assembly language programs; programs that have been compiled to machine language; scripts; and other types of executable software. A software program can comprise two or more software programs that interoperate in some manner.

Hardware Configuration Program—a program, e.g., a netlist or bit file, that can be used to program or configure a programmable hardware element.

Graphical Program—A program comprising a plurality of interconnected nodes or icons, where the plurality of interconnected nodes or icons visually indicate functionality of the program. Can also be referred to as a Virtual Instrument (VI).

Data Flow Graphical Program (or Data Flow Diagram)—A graphical program or diagram comprising a plurality of interconnected nodes, wherein the connections between the nodes indicate that data produced by one node is used by another node. Can also be referred to as a Virtual Instrument (VI).

Graphical User Interface—this term is intended to have the full breadth of its ordinary meaning. The term “graphical user interface” is often abbreviated to “GUI”. A GUI can comprise only one or more input GUI elements, only one or more output GUI elements, or both input and output GUI elements. Can also be referred to as a Virtual Instrument (VI).

The following provides examples of various aspects of GUIs. The following examples and discussion are not intended to limit the ordinary meaning of GUI, but rather provide examples of what the term “graphical user interface” encompasses:

A GUI can comprise a single window, panel, or dialog box having one or more GUI Elements, or can comprise a plurality of individual GUI Elements (or individual windows each having one or more GUI Elements), wherein the individual GUI Elements or windows can optionally be tiled together.

Graphical User Interface Element—an element of a graphical user interface, such as for providing input or displaying output. Exemplary graphical user interface elements include input controls and output indicators.

Input Control—a graphical user interface element for providing user input to a program. Exemplary input controls include buttons, check boxes, input text boxes, knobs, sliders, etc.

Output Indicator—a graphical user interface element for displaying output from a program. Exemplary output indicators include charts, graphs, gauges, output text boxes, numeric displays, etc. An output indicator is sometimes referred to as an “output control”.

Automatically—refers to an action or operation performed by a computer system (e.g., software executed by the computer system) or device (e.g., circuitry, programmable hardware elements, ASICs, etc.), without user input directly specifying or performing the action or operation. Thus, the term “automatically” is in contrast to an operation being manually performed or specified by the user, where the user provides input to directly perform the operation. An automatic procedure can be initiated by input provided by the user, but the subsequent actions that are performed “automatically” are not specified by the user, i.e., are not performed “manually”, where the user specifies each action to perform. For example, a user filling out an electronic form by selecting each field and providing input specifying information (e.g., by typing information, selecting check boxes, radio selections, etc.) is filling out the form manually, even though the computer system must update the form in response to the user actions. The form can be automatically filled out by the computer system where the computer system (e.g., software executing on the computer system) analyzes the fields of the form and fills in the form without any user input specifying the answers to the fields. As indicated above, the user can invoke the automatic filling of the form, but is not involved in the actual filling of the form (e.g., the user is not manually specifying answers to fields but rather they are being automatically completed). The present specification provides various examples of operations being automatically performed in response to actions the user has taken.

Approximately—refers to a value that is almost correct or exact. For example, approximately can refer to a value that is within 1 to 10 percent of the exact (or desired) value. It should be noted, however, that the actual threshold value (or tolerance) can be application dependent. For example, in some embodiments, “approximately” can mean within 0.1% of some specified or desired value, while in various other embodiments, the threshold can be, for example, 2%, 3%, 5%, and so forth, as desired or as required by the particular application.

Concurrent—refers to parallel execution or performance, where tasks, processes, or programs are performed in an at least partially overlapping manner. For example, concurrency can be implemented using “strong” or strict parallelism, where tasks are performed (at least partially) in parallel on respective computational elements, or using “weak parallelism”, where the tasks are performed in an interleaved manner, e.g., by time multiplexing of execution threads.

Various components can be described as “configured to” perform a task or tasks. In such contexts, “configured to” is a broad recitation generally meaning “having structure that” performs the task or tasks during operation. As such, the component can be configured to perform the task even when the component is not currently performing that task (e.g., a set of electrical conductors can be configured to electrically connect a module to another module, even when the two modules are not connected). In some contexts, “configured to” can be a broad recitation of structure generally meaning “having circuitry that” performs the task or tasks during operation. As such, the component can be configured to perform the task even when the component is not currently on. In general, the circuitry that forms the structure corresponding to “configured to” can include hardware circuits.

Various components can be described as performing a task or tasks, for convenience in the description. Such descriptions should be interpreted as including the phrase “configured to.” Reciting a component that is configured to perform one or more tasks is expressly intended not to invoke 35 U.S.C. § 112(f) interpretation for that component.

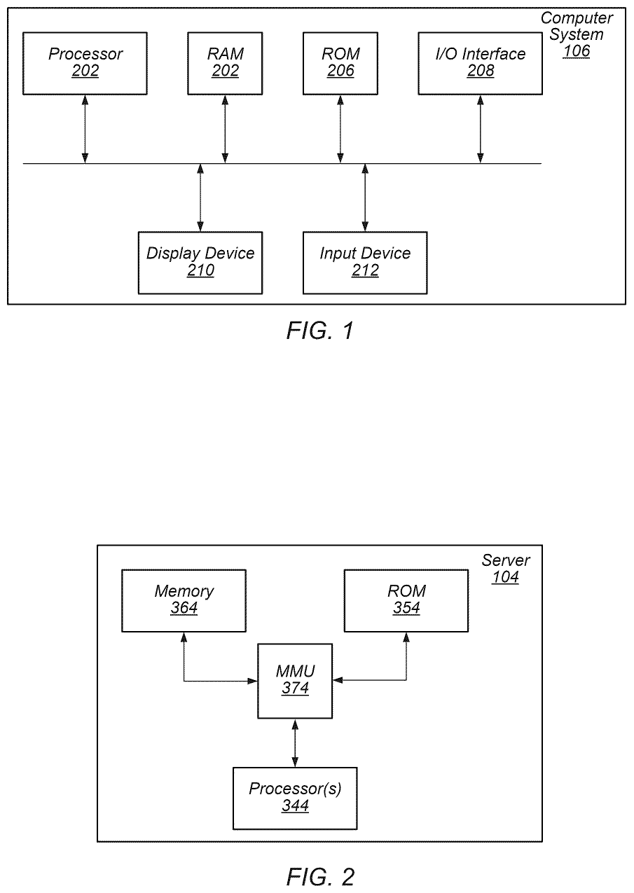

### FIG. 1: Computer System

FIG. 1 illustrates a computer system 106 that can include a processor 202, random access memory (RAM) 204, nonvolatile memory (ROM) 206, a display device 210, an input device 212 and an I/O interface 208 for coupling to sensors. For example, the computer system 106 can include hardware and software components for implementing or supporting implementation of features described herein. The processor 202 can be configured to implement or support implementation of part or all of the methods described herein, e.g., by executing program instructions stored on a memory medium (e.g., a non-transitory computer-readable memory medium). Alternatively, the processor 202 can be configured as a programmable hardware element, such as an FPGA (Field Programmable Gate Array), or as an ASIC (Application Specific Integrated Circuit), or a combination thereof. Alternatively (or in addition) the processor 202, in conjunction with one or more of the other components 204, 206, 208, 210, and/or 212 can be configured to implement or support implementation of part or all of the features described herein.

In addition, as described herein, processor(s) 202 can be comprised of one or more processing elements. In other words, one or more processing elements can be included in processor(s) 202. Thus, processor(s) 202 can include one or more integrated circuits (ICs) that are configured to perform the functions of processor(s) 202. In addition, each integrated circuit can include circuitry (e.g., first circuitry, second circuitry, etc.) configured to perform the functions of processor(s) 202.

As shown, the computer system 106 can include a processor that is coupled to a random access memory (RAM) and a nonvolatile memory. The computer system 106 can also include user interface elements for receiving user input and a display device for presenting output. For example, the user interface elements can include any of various elements, such as a display (which can be a touchscreen display), a keyboard (which can be a discrete keyboard or can be implemented as part of a touchscreen display), a mouse, a microphone and/or speakers, one or more cameras, one or more buttons, and/or any of various other elements capable of providing information to a user and/or receiving or interpreting user input. The computer system 106 can also include an Input/Output (I/O) interface that can be communicatively coupled (e.g., locally via a system bus, or remotely via a network and/or serial interface) to various hardware elements (e.g., such as FPGAs, data acquisition boards, controllers, and the like).

### FIG. 2: Server

FIG. 2 illustrates an example block diagram of a server 104, according to some embodiments. It is noted that the server of FIG. 2 is merely one example of a possible server. As shown, the server 104 can include processor(s) 344 which can execute program instructions for the server 104. The processor(s) 344 can also be coupled to memory management unit (MMU) 374, which can be configured to receive addresses from the processor(s) 344 and translate those addresses to locations in memory (e.g., memory 364 and read only memory (ROM) 354) or to other circuits or devices.

The server 104 can be configured to provide a plurality of devices, such as computer system 106, access to a generative AI, e.g., as further described herein.

In some embodiments, the server 104 can access via a radio access network, such as a 5G New Radio (5G NR) radio access network. In some embodiments, the server 104 can be accessed via a local area network (LAN), e.g., via an ethernet and/or Wi-Fi connection.

As described further subsequently herein, the server 104 can include hardware and software components for implementing or supporting implementation of features described herein. The processor 344 of the server 104 can be configured to implement or support implementation of part or all of the methods described herein, e.g., by executing program instructions stored on a memory medium (e.g., a non-transitory computer-readable memory medium). Alternatively, the processor 344 can be configured as a programmable hardware element, such as an FPGA (Field Programmable Gate Array), or as an ASIC (Application Specific Integrated Circuit), or a combination thereof. Alternatively (or in addition) the processor 344 of the server 104, in conjunction with one or more of the other components 354, 364, and/or 374 can be configured to implement or support implementation of part or all of the features described herein.

In addition, as described herein, processor(s) 344 can be comprised of one or more processing elements. In other words, one or more processing elements can be included in processor(s) 344. Thus, processor(s) 344 can include one or more integrated circuits (ICs) that are configured to perform the functions of processor(s) 344. In addition, each integrated circuit can include circuitry (e.g., first circuitry, second circuitry, etc.) configured to perform the functions of processor(s) 344.

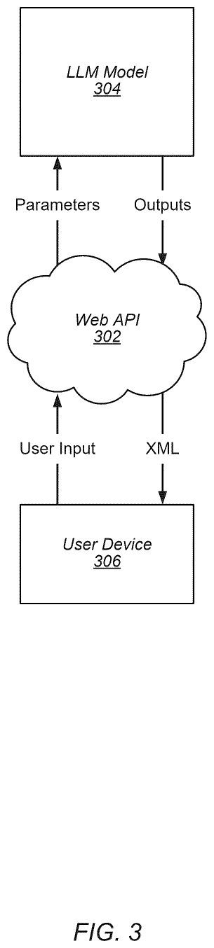

### FIG. 3: Data Analysis System

FIG. 3 illustrates an example of a system supporting a data analysis system, according to some embodiments. As shown, the system can include a user device 306, e.g., which can be a computer system 106 that provides an interface with a LLM model 304 (e.g., which can be hosted on a server, such as server 104) via a web Application Programming Interface (API) 302. In at least some instances, the LLM model 304 can be one or more models 304 (e.g., one or more artificial intelligence models). The interface can allow the LLM model 304 to interact with (e.g., communicate with) local hardware either on the user device 306 and/or in communication with the user device 306. In addition, the interface can allow the LLM model 304 to interact with local software resources (e.g., such as programming platforms (e.g., LabVIEW™, Python, MeasurementLink, C++, MATLAB™, and so forth). Thus, as shown, a user can interact with the LLM model 304 via web API 302 using the user device 306. The user device 306 can execute one or more software resources as well as host hardware (e.g., such as data acquisition boards, control boards, vision boards, and the like) and/or communicate with remote hardware (e.g., such as data acquisition boards, control boards, vision boards, and the like). The user device 306 can provide user inputs, including information regarding available hardware and/or software resources to the web API 302. The web API 302 can convert the user inputs to LLM model parameters and/or the web API 302 can generate LLM model parameters based on the user inputs. The LLM model parameters can be used by the LLM model 304 to generate and/or produce model outputs that are returned to the web API 302. The web API 302 can then convert the model outputs to Extensible Markup Language (XML) and/or generate XML based on the model outputs. For example, the model outputs can include updates to datasets provided to the LLM, e.g., where the updates are based, at least in part, on the user inputs. In this manner, the LLM model 304 can interact with the end user to review and/or revise the datasets. Note that the LLM model 304 can be trained to query end users using a plurality of prompts based on user input. Note further, that aspects of the LLM model 304 can include a user interface executing on the user device 306 as well as background software to discover and maintain hardware information as well as to discover and maintain connections with local applications, the web API 302 to allow the user device 306 to interact with the LLM model 304, and the LLM model 304 that can be executing on a server remote from the user (e.g., the LLM model 304 can be cloud based).

Currently, users in various fields, such as science, engineering, test and measurement, and regulatory compliance, frequently deal with large, complex datasets, including documents, requirements, test results, and intellectual property (IP). These datasets can be uploaded manually by a user or generated by Artificial Intelligence (AI), and in either case typically require review and refinement prior to finalization. However, traditional User Interfaces (UIs) often struggle to balance powerful functionality with usability when handling such large, complex datasets. In general, users require intuitive tools for browsing data (e.g., sorting, filtering, searching, and summarizing) as well as for editing data (e.g., adding, removing, restructuring, and refining). Many existing UI designs fall short because an excessive number of UI elements can lead to overwhelming interfaces, because certain edits can be hard and/or impossible to perform using buttons alone (e.g., “replace the first test in this category with three new functional tests”), and/or because AI-generated content requires human oversight but lacks an efficient review mechanism. Therefore, improvements are desirable.

Embodiments described herein provide systems, methods, and mechanisms for generative Artificial Intelligence (AI) assisted data analysis, e.g., using a generative AI based system to review and refine data. For example, a large language model (LLM), e.g., AI or AI model, can be leveraged as a user interface (UI) element to replace and/or augment functionality found in current UI toolbars. For example, UI elements such as tables, lists, and rich text boxes can include a text field that can function as an interface to the LLM. The text field can function and/or be a chat box for the LLM. For example, a user can request (e.g., command) the LLM to perform one or more actions against current data via the chat box. The LLM can perform the requested one or more actions and update the data. The one or more actions can be cosmetic (e.g., sorting, simple formatting, conditional formatting, and so forth) or semantic (e.g., editing data, adding data, removing data, incorporating formulas, updating formulas, generating charts, generating tables, generating graphs, generating code, and so forth). Further, the LLM can learn from prior requests and/or commands and perform them automatically in the future when presented with similar datasets. In addition, the UI element can be expanded to allow for further queries and/or conversations with the LLM. The UI element can be incorporated into various UIs, such as word processing UIs, presentation UIs, code editor UIs, and/or spreadsheet UIs. In some instances, embodiments described herein can reduce manual effort for a user, particularly in AI augmented workflows, where an AI generates long documents, tables, or other information that must be navigated, reviewed, manipulated, and edited by a user. In addition, in some instances, embodiments described herein can reduce manual effort for a user with regards to compliance issues, such as test validation, requirements review, and/or compliance document generation.

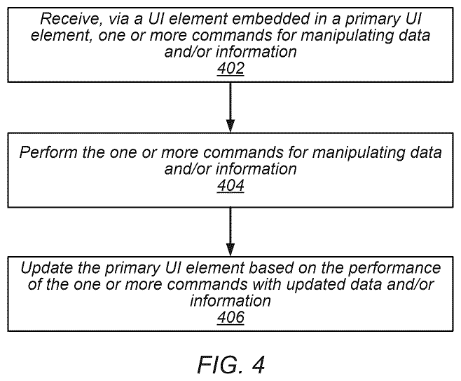

For example, FIG. 4 illustrates a block diagram of example of a method for AI assisted data analysis, according to some embodiments. The method shown in FIG. 4 can be used in conjunction with any of the systems, methods, or devices shown in the Figures, among other devices. In various embodiments, some of the elements shown can be performed concurrently, in a different order than shown, or can be omitted. Additional elements can also be performed as desired. As shown, this method can operate as follows.

At 402, a large language model (LLM), such as LLM 304 (e.g., an Artificial Intelligence (AI) and/or AI model) can receive, via a user interface (UI) element embedded in a primary UI element, one or more commands for manipulating data and/or information. For example, an end user can interact with the UI element in the primary UI element (e.g., a chat box embedded within a spreadsheet UI) on a user device, such as user device 306, to provide instructions to the LLM to manipulate the data and/or the information. The instructions can be provided directly to the LLM from the user device or can be provided to the LLM via an Application Program Interface (API), such as API 302. In some instances, the LLM can be located on a server. The server can be a cloud-based server, at least in some instances. In some instances, the user interface can include a chat box for interacting with and/or providing instructions and/or commands to the LLM. The primary UI element can be a rich text box UI, a word processing UI, a spreadsheet UI, a programming UI, a code editor UI, a presentation UI, and so forth.

At 404, the LLM can perform the one or more commands for manipulating data and/or information. The one or more commands can include cosmetic commands as well as semantic commands. The cosmetic commands can include, among other commands, sorting, simple formatting, conditional formatting, and so forth. The semantic commands can include, among other commands, editing data, adding data, removing data, incorporating formulas, updating formulas, generating charts, generating tables, generating graphs, and so forth.

At 406, the LLM can update the primary UI element with updated data and/or updated information. The updated data and/or updated information can include new data and/or new information. The update can be based, at least in part, on the performance of the one or more commands.

In some instances, the LLM can (automatically) learn from prior commands and perform certain commands automatically in the future when presented with similar datasets. In some instances, the UI element can be expanded and the LLM can receive further queries and converse with an end user.

Embodiments of the present disclosure can be realized in any of various forms. For example, some embodiments can be realized as a computer-implemented method, a computer-readable memory medium, or a computer system. Other embodiments can be realized using one or more custom-designed hardware devices such as ASICs. Still other embodiments can be realized using one or more programmable hardware elements such as FPGAs.

In some embodiments, a non-transitory computer-readable memory medium can be configured so that it stores program instructions and/or data, where the program instructions, if executed by a computer system, cause the computer system to perform a method, e.g., any of the method embodiments described herein, or, any combination of the method embodiments described herein, or, any subset of any of the method embodiments described herein, or, any combination of such subsets.

In some embodiments, a device (e.g., a computer system 106) can be configured to include a processor (or a set of processors) and a memory medium, where the memory medium stores program instructions, where the processor is configured to read and execute the program instructions from the memory medium, where the program instructions are executable to implement any of the various method embodiments described herein (or, any combination of the method embodiments described herein, or, any subset of any of the method embodiments described herein, or, any combination of such subsets). The device can be realized in any of various forms.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method for artificial intelligence (AI) assisted data analysis and review, comprising, by an artificial intelligence model:
receiving, via a user interface (UI) element embedded in a primary UI element, one or more commands for manipulating data and/or information;
performing the one or more commands for manipulating data and/or information; and
updating the primary UI element with updated data and/or updated information based, at least in part, on the performance of the one or more commands.

2. The method of claim 1,
wherein the primary UI element is at least one of a rich text box UI, a word processing UI, a spreadsheet UI, a programming UI, or a presentation UI.

3. The method of claim 1,
wherein the one or more commands are cosmetic commands.

4. The method of claim 3,
wherein the cosmetic commands include at least one of sorting, simple formatting, or conditional formatting.

5. The method of claim 1,
wherein the one or more commands are semantic commands.

6. The method of claim 5,
wherein the semantic commands include at least one of editing data, adding data, removing data, incorporating formulas, updating formulas, generating charts, generating tables, or generating graphs.

7. The method of claim 1, further comprising, by the artificial intelligence model:
receiving, via an expanded UI, an extended query from a user; and
conversing, based on the extended query, with the user via the expanded UI.

8. The method of claim 1, further comprising, by the artificial intelligence model:
automatically learning from prior commands provided by a user; and
automatically performing at least one learned command when presented with a similar dataset.

9. The method of claim 1,
wherein receiving the one or more commands comprises the artificial intelligence model receiving the commands via an application programming interface (API) that converts user inputs into model parameters for the artificial intelligence model.

10. A non-transitory computer-readable memory medium storing program instructions which, when executed by a processor, are configured to cause a computing device to execute an artificial intelligence model to perform operations comprising:
receiving, via a user interface (UI) element embedded in a primary UI element, one or more commands for manipulating data and/or information;
performing the one or more commands for manipulating data and/or information; and
updating the primary UI element with updated data and/or updated information based, at least in part, on performance of the one or more commands.

11. The non-transitory computer-readable memory medium of claim 10,
wherein the one or more commands include at least one cosmetic command and at least one semantic command.

12. The non-transitory computer-readable memory medium of claim 11,
wherein the cosmetic command includes at least one of sorting, simple formatting, or conditional formatting.

13. The non-transitory computer-readable memory medium of claim 11,
wherein the semantic command includes at least one of editing data, adding data, removing data, incorporating formulas, updating formulas, generating charts, generating tables, or generating graphs.

14. The non-transitory computer-readable memory medium of claim 10,
wherein performing the one or more commands includes converting model outputs into a structured data format for updating the primary UI element.

15. The non-transitory computer-readable memory medium of claim 10,
wherein the UI element is expandable to allow continued interaction between a user and the artificial intelligence model after the primary UI element is updated.

16. A computer system, comprising:
a memory;
at least one display; and
at least one processor in communication with the memory and the at least one display, wherein the at least one processor is configured to execute an artificial intelligence model to perform operations comprising:
receiving, via a user interface (UI) element embedded in a primary UI element, one or more commands for manipulating data and/or information;
performing the one or more commands for manipulating data and/or information; and
updating the primary UI element with updated data and/or updated information based, at least in part, on performance of the one or more commands.

17. The computer system of claim 16,
wherein the computer system is configured to interact with at least one local software resource or at least one local hardware resource.

18. The computer system of claim 16,
wherein the artificial intelligence model is executed on a server remote from the computer system.

19. The computer system of claim 18,
wherein the server is a cloud-based server.

20. The computer system of claim 16,
wherein the UI element comprises a chat box embedded within the primary UI element.
